(19) United States
(12) Patent Application Publication
(10) Pub. No.: US 2024/0028555 A1
(43) Pub. Date: Jan. 25, 2024

(54) MULTI-DIMENSIONAL NETWORK SORTED ARRAY INTERSECTION

(71) Applicants: Robert Pawlowski, Beaverton, OR (US); Sriram Aananthakrishna, Lubbock, TX (US); Shruti Sharma, Beaverton, OR (US)

(72) Inventors: Robert Pawlowski, Beaverton, OR (US); Sriram Aananthakrishna, Lubbock, TX (US); Shruti Sharma, Beaverton, OR (US)

(21) Appl. No.: 18/375,359

(22) Filed: Sep. 29, 2023

Related U.S. Application Data
(60) Provisional application No. 63/537,712, filed on Sep. 11, 2023.

(51) Int. Cl. G06F 15/80

(52) U.S. Cl. CPC G06F 15/80

(57) ABSTRACT

Techniques for multi-dimensional network sorted array intersection. A first switch of a plurality of switches of an apparatus may receive a first element of a first array from a first compute tile of the plurality of compute tiles and a first element of a second array from a second compute tile of the plurality of compute tiles. The first switch may determine that the first element of the first array is equal to the first element of the second array. The first switch may cause the first element of the first array to be stored as a first element of an output array, the output array to comprise an intersection of the first array and the second array.

### CROSS-REFERENCE TO RELATED APPLICATIONS

This application claims the benefit of priority of U.S. Provisional Patent Application No. 63/537,712, filed on Sep. 11, 2023. The contents of which is incorporated by reference in its entirety.

### STATEMENT OF GOVERNMENT RIGHTS

The invention was made with Government support. The Government has certain rights in the invention.

### BACKGROUND

Intersection of sorted arrays is an operation used in various computing contexts. Using a single core pipeline to intersect arrays results in degraded performance relative to intersection using hardware parallelization. However, in parallel computing contexts, synchronization between cores is challenging and may introduce additional latency, which may degrade performance.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4 illustrates an aspect of the subject matter in accordance with one embodiment.

FIG. 5 illustrates an aspect of the subject matter in accordance with one embodiment.

FIG. 6 illustrates an aspect of the subject matter in accordance with one embodiment.

FIG. 7 illustrates an aspect of the subject matter in accordance with one embodiment.

FIG. 8 illustrates an aspect of the subject matter in accordance with one embodiment.

FIG. 9 illustrates an aspect of the subject matter in accordance with one embodiment.

FIG. 10 illustrates a logic flow 1000 in accordance with one embodiment.

FIG. 11 illustrates an aspect of the subject matter in accordance with one embodiment.

### DETAILED DESCRIPTION

Embodiments disclosed herein provide a full architectural approach to support sorted array intersection operations in a scalable system using a network of configurable switches. More specifically, embodiments disclosed herein may define specific instructions in an Instruction Set Architecture (ISA) for various operations used to process sorted array intersections. Furthermore, embodiments disclosed herein may include hardware modifications to the compute path within each network switch, which may include providing hardware functionality to send input arrays to the switch network and receive output arrays from the switch network.

Embodiments disclosed herein may improve system performance by implementing an array intersection in configurable switch hardware of a parallel computing system. The system performance improvement may increase as the number of arrays being intersected increases and/or when the array sizes are large. By providing new ISA instructions and hardware management of the full intersection operation, the complexity of software to implement the array intersection may be reduced.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 121 illustrated as components 121-1 through 121-a may include components 121-1, 121-2, 121-3, 121-4, and 121-5. The embodiments are not limited in this context.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

An emerging technology that is optimized for large scale graph analytics may include parallel computing architectures such as the NVIDIA® Graphcore, Cray® Graph Engine, and others. An example parallel computing architecture may include many multi-threaded core nodes that utilize memory transactions to take advantage of fine-grained memory and network accesses. The multi-threaded core nodes may share a global address space and have powerful offload engines. The multi-threaded core nodes of the computing architecture provide a hardware mechanism for scheduling work across a relatively large distributed system via, for example, intersecting two or more sorted arrays to determine common elements (if any) in each array.

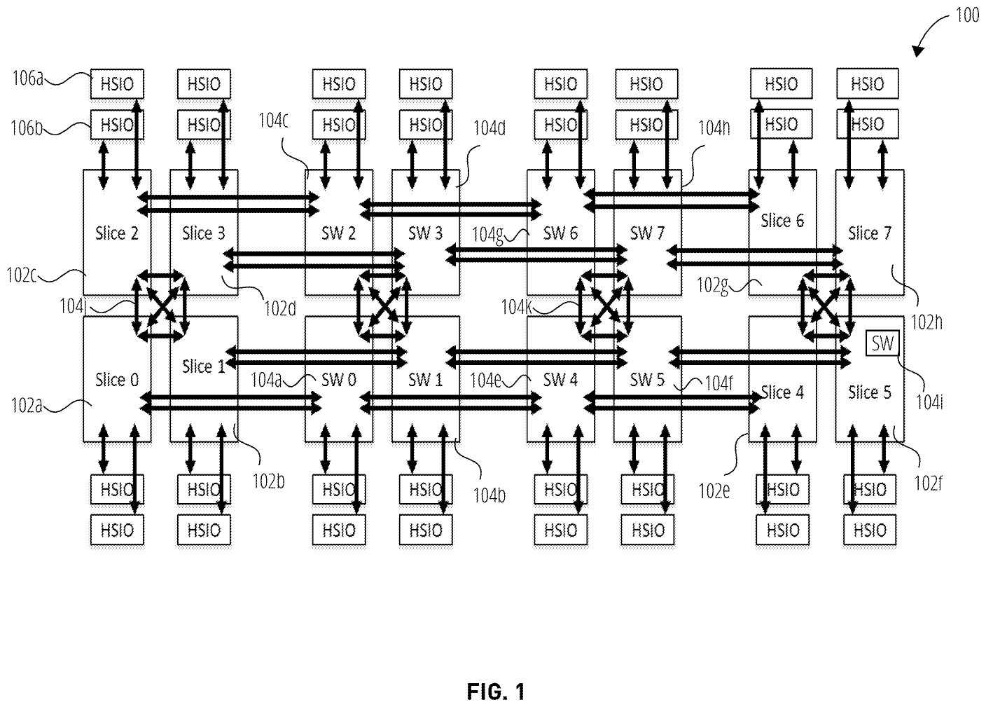

FIG. 1 illustrates an example system 100. The system 100 may be referred to as an “in-network collective subsystem” herein. According to some examples, system 100 may be elements of a system-on-chip (SoC), die, or semiconductor package that provides a scalable machine. The scalable machine may target dense and/or sparse-graph applications (also referred to as “graph analytics applications”) on datasets that may be very large (e.g., up to 10 petabytes in size or more). To address these targets, the system 100 may use a distributed global address space and a highly scalable low-diameter and high-radix network to scale up to numerous sockets.

Generally, system 100 may represent a high-level diagram of a single SoC, which may also be referred to as a “tile” herein. For these examples, system 100 may include eight multi-threaded compute slices 102a-102h, each slice having a corresponding intra-die or intra-package switch (e.g., switch 104j) to allow packets into and out of a scalable system fabric. The compute slices 102a-102h may also be referred to as “compute cores” herein. Also, compute slices 102a-102h may each separately couple to two high speed input/outputs (HSIOs) (e.g., HSIO 106a-106b—each HSIO not labeled for clarity) to allow for inter-die or inter-package connectivity across multiple slices, SoCs, dies, and/or semiconductor packages in a larger system (e.g., maintained on a same or different board, same or different compute platform nodes or same or different racks). In other examples, each slice 102a-102h may include one or more multiple instruction, multiple data (MIMD) multi-threaded pipelines and one or more coprocessors. In one example, each of slices 102a-102h includes 8 MIMD multi-threaded pipelines, where each pipeline has an associated coprocessor (for 8 total coprocessors in each slice). The switches 104j-104k are distributed in the system 100. Each switch 104j-108b include a connection to a “local” slice 102a-102h in the tile. For example, switch 104j includes connections to slices 102a-102d.

In one example, the system 100 may support up to 100,000 sockets in a single system. A single socket of the system 100 may support any number of tiles, such as 16 tiles. Each tile may in turn include any number of slices, such as 8 slices. As stated, a single tile may include any number of MIMD processor pipelines, such as 8 MIMD pipelines. A single MIMD pipeline may include a multi-threaded pipeline. Therefore, in an example configuration of a tile with 8 slices, where each slice has 8 MIMD pipelines, each tile of the system 100 may provide 64 distinct pipelines. In some embodiments, the MIMD pipeline is based on the RISC-V® ISA executing on compatible processor circuitry. However, other pipelines, ISAs, and/or other processors can be used. Each tile may include connectivity to local memory (not pictured for clarity) via one or more memory controller (not pictured) interfaces.

According to some examples, to support in-die or in-semiconductor package network porting to HSIOs and inter-die connectivity, system 100 includes switches (SW), namely switches 104a-104h having respective HSIOs (not labeled for clarity). As shown, switches 104a-104h couple with respective slices 102a-102h as illustrated by respective parallel pairs of double arrows. As shown, switches 104a-104h may include an intra-die switch (e.g., switch 104k for the die including switches 104e-104h. Similarly, switch 104j may be an intra-die switch for the die including slices 102a-102d. Furthermore, each of slices 102a-102h may include a respective switch, such as switch 104i (switches in other tiles not pictured for clarity) corresponding to switches 104a-104h or 104j-104k. The elements of FIG. 1, including but not limited to the slices 102a-102h, switches 104a-104k, and HSIOs 106a-106b may be implemented in circuitry and/or a combination of circuitry and software. Generally, each switch 104a-104k may support configurable, collective communication for parallel computing operations, including sorted array intersection operations.

In some examples, a network topology includes nodes having groupings of four slices 102a-102h or four switches 104a-104h as respective tiles. For example, a first tile may include slices 102a-102d, while a second tile may include switches 104a-104d, a third tile may include switches 104e-104h, and a fourth tile may include slice 102e-102h. A cluster of arrows shown in FIG. 1 for each of tile signify possible routes (e.g., via switch 104j, switch 104k) for an intra-die, switch-based collective operations, such as operations to intersect two or more sorted arrays. In some embodiments, a “pod” includes a group of four slices and associated switches, e.g., a first pod may include slices 102a-10d and switches 104a-104d, etc.). Examples in this disclosure will describe more details below of this switch-based collective sorted array intersection operation.

Beyond a single die, system configurations can scale to multitudes of nodes with a hierarchy defined as sixteen die per subnode and two subnodes per node. Such network switches can include support for configurable collective communication. In some examples, a die can include one or more core tiles and one or more switch tiles. In some examples, four cores can be arranged in a tile; four switches can be arranged in a tile; four tiles can be arranged in a die; and thirty-two die can part of a node. However, other numbers of cores and switches can be part of a tile, other numbers of tiles can be part of a die, and other numbers of die can be part of a node.

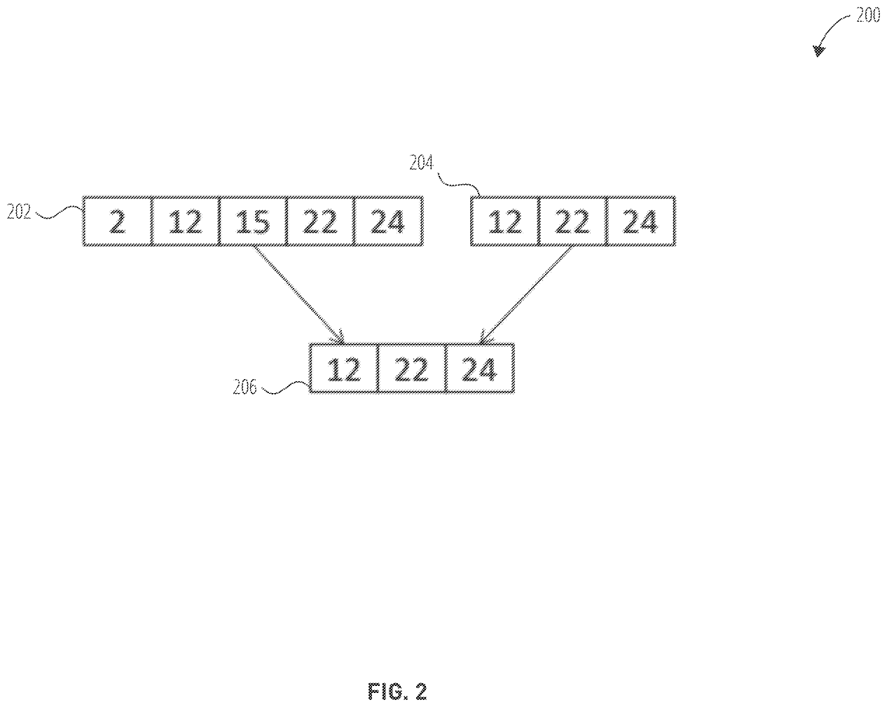

FIG. 2 is a schematic 200 illustrating an example of intersecting two sorted arrays. As shown, input array 202 includes five elements and input array 204 includes three elements. The elements of input arrays 202, 204 are sorted according to the corresponding values, e.g., from least to greatest. The intersected array 206 is an output of an intersection operation between the two input arrays 202, 204. As shown, intersected array 206 includes common elements found in each of input array 202 and input array 204, namely “12”, “22”, and “24”. Furthermore, the entries of intersected array 206 are sorted, e.g., from least (or minimum) value to greatest (or maximum value). Embodiments are not limited in this context.

To compute the intersection, both input arrays 202, 204 are compared at each element. In the event of a match, the common elements are copied to the output intersected array 206 and both input arrays are incremented. If there is no match, the input array 202, 204 with the minimum value element is incremented for the next iteration of the loop. The input array 202, 204 that did not have the minimum value element in the current iteration is not incremented for the next iteration. The iteration terminates when the end of one of the input arrays 202, 204 is reached, as there cannot be common elements when one array no longer has elements remaining.

Identifying common elements in two or more sorted arrays (e.g., intersecting two or more sorted arrays) may be used in a variety of purposes in graph analytics and/or database applications. In the graph analytics domain, computing the intersection of two arrays is useful to find common neighbors between any pair of vertices whose neighbors are described using adjacency lists. As another example, computing common neighbors between vertices may be used when counting the number of triangles in a given graph.

Array intersection operations may also used when computing the ego networks of vertices in a graph. An ego network of a vertex may be a smaller subgraph consisting of an ego node (the vertex of interest) with direct connections to both its incoming and outgoing neighbors (referred to as friends of the ego node). In addition to these direct connections, an ego network also includes friends-of-friends which are connections between the neighbors of the ego node. Finding friends-of-friends is an expensive task as it requires computing the intersection between all neighbors of a “friend” and all nodes in the ego network including the ego node and its immediate friends. This task must be repeated for every friend of the ego node. Ego networks are very commonly used in social network analysis and in Graph Neural Network (GNN) based recommendation systems.

From a hardware implementation perspective, executing an intersection operation of two sorted input arrays on a single pipeline includes loading each element of each input array in sequence and comparing element values at each iteration. If there is no match, the next value of the input array with the current lower-valued element may be fetched for the next iteration. If there is a match, the matching value may be stored to the output array, and the next element for both input arrays may be fetched. Each iteration may require at least two load instructions, a compare, control operations depending on the result of the compare, any array pointer increments, and potentially a store of the result. Compiler optimizations may remove one of the load instructions if the loaded value is reused from the previous iteration, leaving the instruction count for each iteration anywhere from five to seven instructions.

An intersection operation between two arrays may be difficult to implement in parallel due to the dependency between aforementioned iterations of the intersection algorithm. However, the intersection operation may become more parallelizable as more unique input arrays are involved in the operation. For example, separate cores may execute the intersection among different input array pairs, and their results may be intersected with each other. Ultimately, the performance may be limited by the synchronization cost between the different cores as well as any load balancing issues.

Therefore, implementing such intersection operations may be challenging in a parallel system such as system 100. For example, the size of the output array is not a known value before the intersection operation begins and is dependent on the total number of common element values across all input arrays. The system 100 may provide a full architectural approach to support sorted array intersection operations as described in greater detail herein.

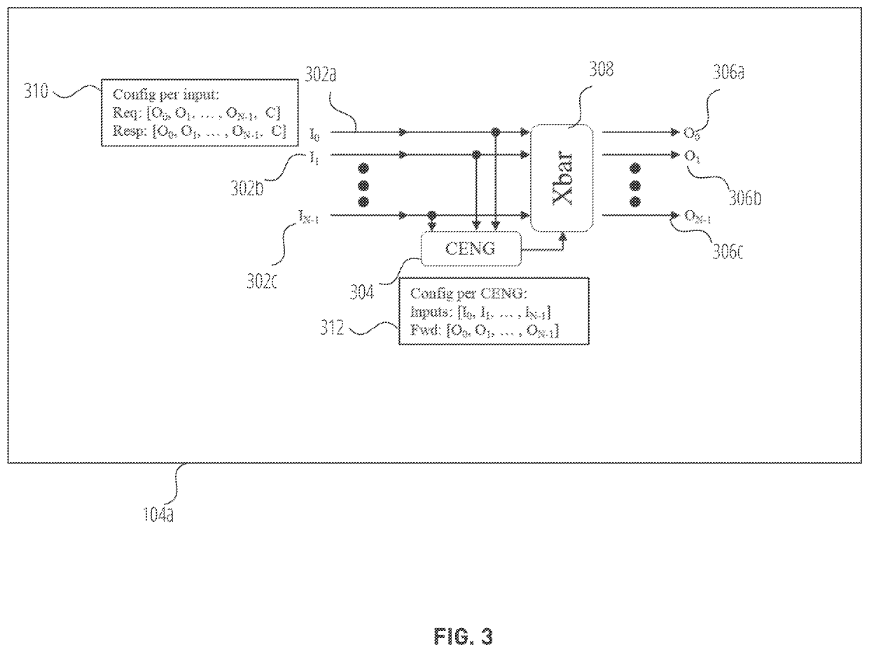

FIG. 3 illustrates components of switch 104a in greater detail, according to one example. Switch 104a is used as a reference example in FIG. 3. However, the components depicted in FIG. 3 may be included in each switch 104b-104k. Furthermore, the components depicted in FIG. 3 may be included in the respective switches of each slice 102a-102h, such as switch 104i of slice 102f. As shown, the switch 104a includes N ports, where N is any positive integer. For example, as shown, switch 104a may include input ports 302a-302c and output ports 306a-306c. Furthermore, the switch 104a includes a collective engine (CENG) 304, a crossbar 308, and a plurality of registers including configuration registers 310 and configuration registers 312. The collective engine 304 may include the hardware units required to compute array intersections. The crossbar 308 may be an interconnect that couples input ports 302a-302c to output ports 306a-306c.

The configuration registers 310 include, for each input port 302a-302c, a request (Req) configuration register for the forward path of an array intersection operation and a response (Resp) configuration register for the reverse path of the intersection operation. During the forward path of an intersection operation, value comparison operations are performed via circuitry to determine whether two values match. The values may be associated with two or more arrays such as input arrays 202, 204. The forward path may further include circuitry for additional operations to handle various cases, e.g., when two values are equal, when two values are not equal, etc. During the reverse path of the intersection operation, the final value is returned to the core assigned as responsible for receiving the final output array. For example, software may specify one of slices 102a-102h as the core responsible for receiving the final output array. Embodiments are not limited in this context.

More specifically, the request configuration registers 310 include a bit vector which represents the output port that each input port is forwarded to. For example, the request configuration registers 310 for input port 302a may specify that the input port 302a is forwarded to output port 306a. Furthermore, the request configuration registers 310 include a bit (labeled “C”) in FIG. 3 to indicate if the input port is providing its value to the collective engine 304 for computation (e.g., comparison) for the intersection operation. Therefore, the collective engine 304 includes circuitry to determine whether two or more input values match (or are equal). In the event two values being compared are not equal, the collective engine 304 may include circuitry to select one of the values as the maximum value and reuse the maximum value in another comparison operation. In some embodiments, the bit vector of an input port does not have any bits set (e.g., all bits may have zero values).

The configuration registers 312 define the configuration for the collective engine 304. As shown, the configuration registers 312 include input registers that define which of the input ports 302a-302c will provide values for a comparison computation to be performed by the collective engine 304. The configuration registers 312 further include forward (“Fwd”) registers that define one or more output ports 306a that the output of the collective engine 304 (e.g., a maximum value of two or more values and/or an intersected value present in both input arrays) is to be forwarded through.

In some embodiments, the tile network and port connections of the collective engine 304 assume that each slice sends a single stream of values into the network collective subsystem via the connection to its local switch. In such embodiments, each slice includes the ability to execute the collective between the eight pipelines in the slice first before sending the value into the intra-tile network. The configuration concept for this in-slice region of the collective operation may be the same as the configuration concept described for the intra-tile switches.

As stated, the collective engine 304 may include circuitry to perform array intersection operations by determining common elements in two or more sorted arrays. Further still, the collective engine 304 may include circuitry to retain the maximum value for use during the next iteration of the intersection operation. For example, if the collective engine 304 determines that “4” is the maximum value among the values “1” and “4”, the value “4” is retained by the collective engine 304 for use in the next value comparison operation (e.g., compared to another element of another array). Furthermore, the collective engine 304 may include circuitry to select valid inputs when one of the input arrays has no further elements to contribute to the intersection operation. More generally, the collective engine 304 may include circuitry and/or software to read input arrays from memory, push data into the network, receive the output array from the network, and write the final output array into memory.

In some embodiments, ISA instructions may be supported to initiate an array intersection operation. A given pipeline may issue an ISA instruction to a local engine which may read each element of an input array and issue requests into the network collective subsystem. The ISA instructions may further include instructions for receiving an intersected output array such as intersected array 206 and writing the intersected array 206 to memory. In some embodiments, mechanisms for alerting software that the intersection operation has completed. Because the number of elements of the intersected array 206 is unknown when the operation begins (because zero, some, or all input array elements may be common to both arrays), embodiments disclosed herein provide techniques to determine when the full output array has been written to memory. Furthermore, embodiments provide techniques to inform software initiating the intersection that the intersection has been completed, a location of the output array, and other relevant information.

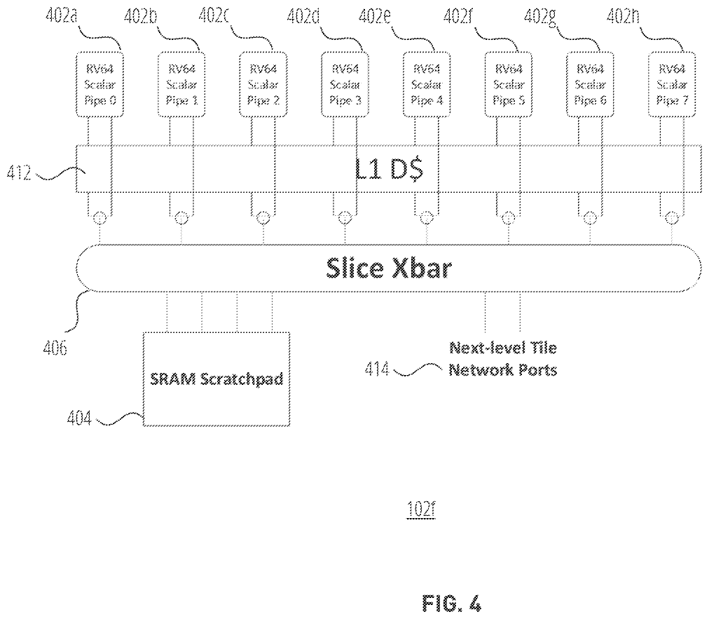

FIG. 4 illustrates components of an example compute slice, such as slice 102f, in greater detail. As shown, the slice 102f includes a plurality of processor pipelines 402a-402h, a scratchpad 404 memory (e.g., to store data during computations), and a data cache 412 coupled via crossbar switch 406. The slice 102f includes multiple output ports 414 to connect to other tiles, slices, and/or switches of the system 100. The slice 102f may further include local configuration and status registers (not pictured) that are used for the local network collective configuration.

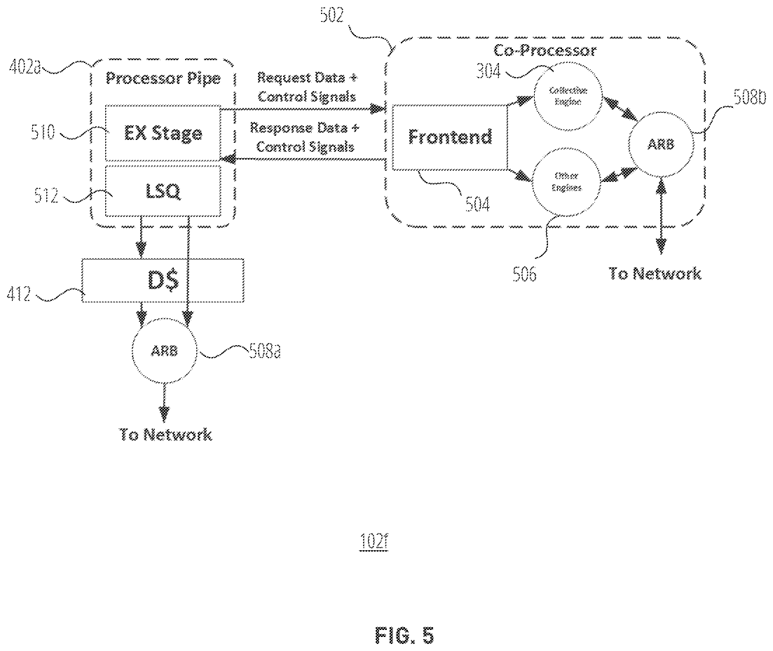

To facilitate sorted array intersection operations, the system 100 may define ISA extensions (e.g., ISA instructions) and include modifications to the slices 102a-102h to initiate an intersection operation. Generally, the pipelines 402a-402h may issue an instruction defined by the ISA to initiate the intersection operation. The instruction may be referred to herein as a “intersection.send” instruction. An intersection.send instruction may be issued by each thread that is contributing an input array to the intersection operation. When a thread executes the intersection.send instruction, it will ship the full instruction to the pipeline's partner coprocessor (e.g., coprocessor 502 of FIG. 5) for processing. The intersection.send instruction includes inputs for the base address of the input array, the SIZE of each array element, and the total number of elements. Because multiple connectivity configurations are supported, the intersection.send instruction includes a value specifying the configured network tree ID.

Table I below includes detail describing example ISA instructions to support intersection operations, including the instruction name, instruction arguments, and descriptions of each argument.

TABLE I

| | ASM Form | |
|---|---|---|
| Instruction | Arguments | Argument Descriptions |
| intersection.send | r1, r2, r3, | r1 = Intersection tree ID; |
| | SIZE | r2 = Input Array Base Address; |
| | | r3 = Number of elements (of |
| | | SIZE) in input array |
| intersection.receive | r1, r2, SIZE | r1 = Intersection tree ID; |
| | | r2 = Output Array Base Address; |
| intersection.poll | r1, r2, r3 | r1 = if operation is complete, |
| | | return the number of elements |
| | | in the output array, else return |
| | | 0; r2 = if operation is complete, |
| | | return base address of output |
| | | array, else return 0; |
| | | r3 = intersection tree ID; |
| intersection.wait | r1 | r1 = return the number of |
| | | elements in the output array; |
| | | r2 = return base address of |
| | | output array; r3 = intersection |
| | | tree ID |

The intersection.receive instruction is issued by one thread that will receive the output array elements from the intersection operation and store the output array elements in memory. When a thread executes the intersection.receive instruction, the thread may ship the full intersection.receive instruction to the pipeline's partner coprocessor for processing. The instruction includes input arguments for the base address of the output array and the SIZE of each array element. Because multiple connectivity configurations are supported, the instruction includes a value specifying the configured network tree ID. This instruction must be issued before the intersection operation has begun to properly set the output memory location before data arrives at the thread's local coprocessor.

The intersection.poll instruction may be issued by one thread that is to receive the final output array of the intersection operation (e.g., the final intersected output). The intersection.poll instruction is non-blocking to the thread. As shown in Table I, the arguments to intersection.poll include r1, r2, and r3. Generally, the intersection.poll instruction returns a 0 in the r1 field is the intersection operation is not complete. If the operation is complete, the number of elements in the output array are returned in the r1 field. If the operation is complete, the base address of the output array (and/or the number of elements of the output array) are returned in the r2 field. Argument r3 corresponds to the identifier of the tree processing the intersection operation.

The intersection.wait instruction may be issued by one thread that is to receive the final output array of the intersection operation. The intersection.wait instruction may function similarly to intersection.poll, except that it is blocking to the issuing thread, e.g., it will not allow forward progress of the issuing thread until it returns a valid base address and element count of the output array. If the intersection operation is not complete when the instruction is issued, it will wait until the instruction is complete. As shown in table I, the arguments for intersection.wait include r1, r2, and r3. Generally, r1 returns the number of elements in the output array, r2 returns the base address of the output array, and r3 returns the identifier of the tree processing the intersection operation.

The intersection.send, intersection.receive, intersection.poll, and intersection.wait instructions are examples of ISA instructions. However, embodiments are not limited in these contexts, as other ISA instructions may be used. For example, a subset of the bits allocated to the tree ID may be specified. Similarly, the intersection.poll and intersection.wait instructions may return the end address of the output array instead of the number of elements in the output array. As another example, an ISA instruction may specify to intersect two or more arrays (e.g., “intersection (array[0], array[1])), where the instruction specifies at least a base address of the respective arrays to be intersected. As another example, an ISA instruction may specify to intersect a number of arrays (e.g., intersection(number_of_arrays)), where the instruction specifies at least a base address of the respective arrays to be intersected.

FIG. 5 illustrates components of an example compute slice 102f in greater detail. As shown, the slice 102f depicts processor pipeline 402a, which is one of the processor pipelines 402a-402h (pipelines 402b-402h not depicted for the sake of clarity). The pipeline 402a includes an execution stage 510 and a load-store queue 512 coupled to the data cache 412, which is in turn connected to other components of the collective subsystem 100 (e.g., switches 104a-104k, slices 102a-102h, other tiles, etc.).

The compute slice 102f further includes a coprocessor 502. The coprocessor 502 includes one or more frontend 504 interfaces, a collective engine 304, one or more other engines 506, and an arbiter 508b. The one or more frontend 504 interfaces to the pipeline 402a to support function creation and blocking/non-blocking communication between the pipeline 402a and coprocessor 502. The coprocessor 502 includes a collective engine 304 that operates on the collective instructions and send/receive packets to/from the in-network collective subsystem. Although the collective engine 304 of FIG. 3 is depicted in the coprocessor 502, in some embodiments, the collective engine 304 of the coprocessor 502 is different than the collective engine 304.

The collective engine 304 of coprocessor 502 generally includes the circuitry to perform array intersection operations described above. For example, the collective engine 304 may include circuitry to retain the maximum value for use during the next iteration of the intersection operation. For example, if the collective engine 304 determines that “4” is the maximum value among the values “1” and “4”, the value “4” is retained by the collective engine 304 for use in the next value comparison operation (e.g., compared to another element of another array). Furthermore, the collective engine 304 of coprocessor 502 may include circuitry to select valid inputs when one of the input arrays has no further elements to contribute to the intersection operation. More generally, the collective engine 304 may include circuitry and/or software to read input arrays from memory, push data into the network, receive the output array from the network, and write the final output array into memory.

Collectively, the processor pipeline 402a and the coprocessor 502 form a processing element (PE). Each pipeline 402a-402h may include a respective coprocessor 502 (and other elements depicted in FIG. 5). Generally, the coprocessor 502 may execute the ISA instructions that may not be supported by the ISA of the pipeline 402a. For example, the coprocessor 502 may execute the intersection.send, intersection.receive, intersection.poll, and intersection.wait instructions that are issued by a thread executing on one of pipelines 402a-402h and shipped to the respective coprocessor 502 by the respective pipeline 402a-402h.

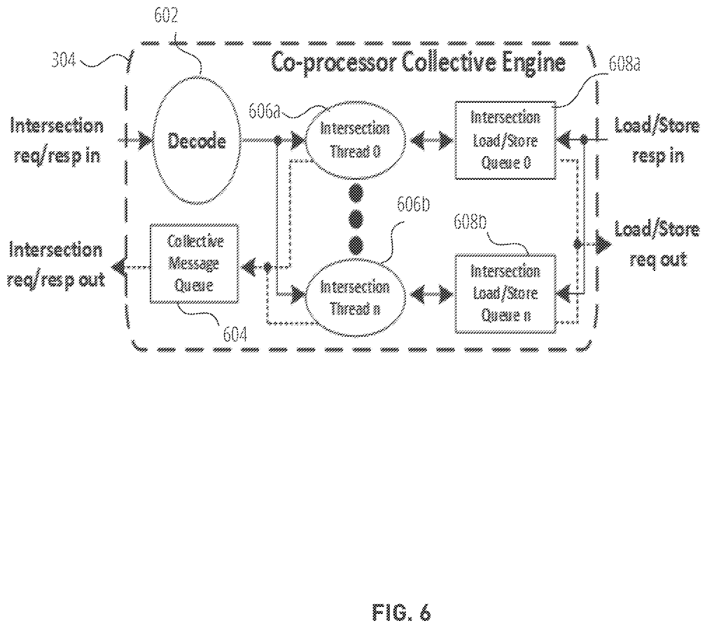

FIG. 6 shows the components of the collective engine 304, according to one example. The components of the collective engine 304 depicted in FIG. 6 may be included in the collective engine 304 of the coprocessor 502 and/or the collective engine 304 of the switches 104a-104k. As shown, the collective engine 304 includes a decoder 602, a collective message queue 604, one or more intersection threads 606a-606b (where each intersection thread is associated with a respective identifier), and one or more load/store queues 608a-608b, where each load/store queue 608a-608b is associated with a respective one of the intersection threads 606a-606b.

Generally, ISA intersection instructions (e.g., intersection.send, intersection.receive, intersection.poll, and intersection.wait instructions) may be received by the decoder 602. The decoder 602 may decode the instruction and provide the decoded instruction to one of the intersection threads 606a-606b based on the identifier in the instruction. Therefore, each intersection thread 606a-606b may manage one or more sorted array intersection operations, each operation having an associated unique ID. The load/store queue 608a may be a queue for memory requests (e.g., to read each element of the input array and/or to write each element of the output array). For example, when an element of the input array is read from memory, the element may be stored in the load/store queue 608a-608b of the associated intersection thread 606a-606b. Similarly, when the intersection thread 606a-606b receives an output value to be written to the output array, the output value may be stored in the load/store queue 608a-606b of the associated intersection thread 606a-606b before being written to memory.

The collective message queue 604 is a shared queue for sending input array element requests to the in-switch collective subsystem (e.g., sending input array elements to other slices 102a-102h and/or other switches 104a-104k). In some embodiments, backpressure may occur (e.g., when one element of an array is the maximum value in a comparison operation that did not result in a match, that element is reused in the next comparison operation, thereby creating backpressure). Therefore, the collective message queue 604 may store elements of the array in the event of backpressure (e.g., to store a next element in the array while the previous element is reused in the next comparison operation).

As stated, intersection.send instructions may be issued from one or more of pipelines 402a-402h. When such an ISA-defined intersection.send instruction is issued by pipeline 402a-402h, the instruction is sent to the collective engine 304 of the coprocessor 502 of the pipeline 402a-402h (e.g., the coprocessor 502 of the PE) issuing the instruction. The collective engine 304 may then assign the intersection.send instruction to the corresponding intersection thread 606a-606b associated with the ID specified in the intersection.send instruction. The intersection thread 606a-606b then performs the following operations based on the base address and number of elements specified in the intersection.send instruction. Starting with the base address as a target address, which may be a 64-bit address, the intersection thread 606a-606b makes load requests for elements of the size specified in the instruction to the target memory where the input array is stored. Doing so causes a request for each element of the array to be returned from memory. For each element, the target address is the address of the previous element plus the size of one element. Therefore, for the second element in the array, the target address is the base address plus the size of one element.

As each array element is returned responsive to the load requests, the value of the array element is stored in the collective message queue 604. The value is the outputted to the collective subsystem in one or more request packets, or messages (e.g., sent to other slices 102a-102h and/or other switches 104a-104k to be used in intersection operation computations). Doing so may cause each element of the input array received from memory to be pushed to the collective subsystem for intersection operation computations. A request packet may include the following information depicted in Table II:

TABLE II

| Packet Field | | |
|---|---|---|
| Name | Description | Width |
| Tree ID | ID of the network collective tree to | 3 bits |
| | use. The network collectives support | |
| | multiple concurrent trees. | |
| Data Size | The size of the data field for the | 2 bits |
| | operation. (2‘b00 = 1B, 2‘b01 = 2B, | |
| | 2‘b10 = 4B, 2‘b11 = 8B) | |
| Data | Data to be used for the intersection | 64 bits |
| | operation. | |
| Collective Type | Specify type of operation to execute at | 3 bits |
| | the switch collective engine 304. | |
| | (3‘b000 = barrier, 3‘b001 = reduction, | |
| | 3‘b010 = multicast, 3‘b011 = merge, | |
| | 3’b100 = intersection, 3‘b101 = | |
| | intersection completed) | |

As shown, a request packet may include the ID of the network collective tree, a size of the data (e.g., the size of an element of the input array), the data to be used in the intersection operation (e.g., the value of the element of the input array), the type of operation to be performed at the collective engine 304 (e.g., an intersection operation).

For each element of the input array, the collective engine 304 keeps track of the count of load requests made to memory and a count of returned loads sent to the in-network collective subsystem. Once all elements of the input array have been sent via the collective message queue 604, the collective engine 304 may transmit a final packet (e.g., to the receiving switch 104a-104k and/or slice 102a-102h) indicating that all elements of the input array have been sent (e.g., no additional elements of the input array remain). Once the final packet is sent, the intersection.send operation is complete.

For each sorted array intersection operation, the collective engine 304 of one slice 102a-102h is specified to receive all elements of the final output array, which may be predetermined (e.g., specified in the intersection.receive instruction). As output array elements are received in order from the collective engine 304 of the switch 104a-104k, these elements are stored in order in a memory location. The memory location may be predetermined, e.g., defined by software. The collective engine 304 of the coprocessor 502 receiving the final output array may be initialized via the intersection.receive instruction. The instersection.receive instruction may precede the intersection and may set values in the configuration registers associated with the ID specified in the instruction. The configuration registers may be defined in Table III below:

TABLE III

| MSR Name | Description | Width |
|---|---|---|
| Output Base | Base address of the output array. | 64 bits |
| Address | | |
| Size | Output array element size | 2 bits |
| Enable | When asserted, all other MSRs have | 1 bit |
| | been configured and the collective | |
| | engine 304 of the coprocessor 502 is | |
| | ready to receive data | |

As shown, the configuration registers may include, for an associated tree ID, a base address of the output array, the size of an element of the output array, and an enable bit. In some embodiments, the values for the output array depicted in Table III may be defined by issuing an intersection.receive instruction that specifies the output base array address and the size of each element of the output array. Once these values are written to the configuration registers (e.g., configuration registers 310 and/or configuration registers 312), the enable bit in the registers is asserted. The assertion of the enable bit allows the collective engine 304 to accept packets from the in-network collective subsystem.

The input arrays may then be fed into the in-network collective subsystem, where the intersection is processed by the switches 104a-104k and/or the slices 102a-102h. Generally, output array elements are received by the collective engine 304 in order. As each element is received, the collective engine 304 generates a store request of the element's data value to the memory location of the output array. Doing so causes the first element to be stored at the base address specified in the configuration registers, while each successive element's target address is the previous element's address plus the size of one output array element. Therefore, for the second element in the output array, the target address is the base address plus the size of one element of the output array.

The collective engine 304 may maintain a count of the number of output array elements received. After receiving the final output array element, the collective engine 304 may receive an end-of-operation packet from the in-network collective subsystem. Once the end-of-operation packet is received, the collective engine 304 considers the intersection operation to be completed, and the collective engine 304 may notify software that the operation is completed.

The collective engine 304 of a coprocessor 502 may notify the requesting software executing on the corresponding pipeline 402a-402h via push (e.g., an interrupt) or poll operation. For example, in a push embodiment, the collective engine 304 of the coprocessor 502 may generate an interrupt that will be sent to the partner pipeline 402a of the PE. This interrupt routine may inspect the status of the intersection operation by inspecting the status registers of the collective engine 304 of coprocessor 502 associated with the ID (e.g., to determine if the full output array has been written to memory).

In the poll embodiment, one of the threads (e.g., executing on pipelines 402a-402h) of the slice associated with the final output array may poll the intersection threads 606a-606b at periodic intervals using the intersection.poll instruction. If successful, the collective engine 304 may return the base address of the final output array and the element count of the final output array to the thread that issued the intersection.poll instruction. In the intersection.push or the intersection.poll embodiments, the software on the pipeline 402a-402h may access or otherwise use the intersected output array.

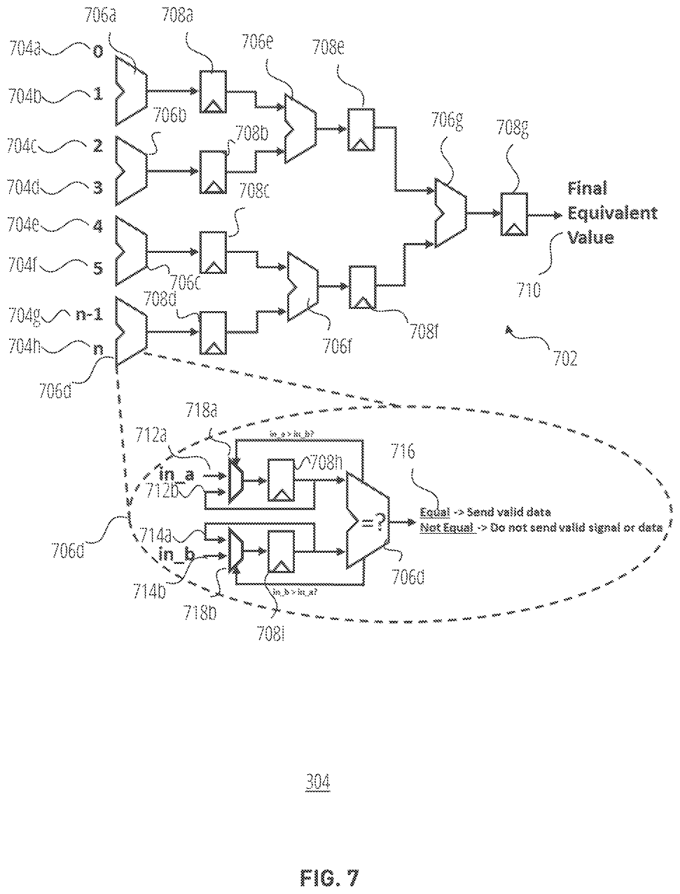

FIG. 7 illustrates the components of the collective engine 304 in greater detail, according to one example. As shown, the configuration registers 312 of the collective engine 304 may define a tree 702 associated with an intersection operation (which may be identified via a unique identifier). The tree 702 defines a full compute path for sorted array intersection operations within the collective engine 304, which is a tree of execution stages. The depth of the tree 702 may be determined based on the number of input ports 302a-302c that feed into the collective engine 304 of the switch 104a-104k. For example, if there are eight input ports participating in the intersection operation, the tree 702 may include three compare stages and seven total execution units (e.g., arithmetic logic units (ALUs) and/or floating point units (FPUs)).

As stated, the collective engine 304 includes circuitry for “if-equal” conditional comparison operations. For example, the collective engine 304 includes circuitry to compare two values to determine whether the values are equal. If the values are equal, the collective engine 304 may include circuitry to forward one of the values as an element of an intersected output array. In some embodiments, the value is forwarded to the next ALU and/or FPU of the tree 702. If the comparison indicates the values are not equal, the collective engine 304 includes circuitry to determine the maximum value of the compared (but unequal) values. For example, if the values “10” and “100” are compared, the collective engine 304 determines that the value “100” is the maximum value. Furthermore, the collective engine 304 includes circuitry to reuse the maximum value (e.g., “100” in the preceding example) in the next comparison iteration. In such an example, another value from the array that did not have the maximum value is compared to the maximum value in the next iteration.

The collective engine 304 may forward an “end of array” indication to the next ALU in the tree 702 if one or more of the inputs has no more valid data to send through the collective network. For example, for an intersection of input arrays A and B, if input A has no more elements, the operation is completed regardless of whether input B has elements remaining (as there can be no matching elements). If input B does continue to send remaining elements to the collective engine 304, the collective engine 304 may accept these values (even though they just be dropped and will not be compared) to allow for forward progress.

Because the collective engine 304 of the coprocessor 502 receiving the intersected output array does not know how many elements are in the array, a collective engine 304 participating in the intersection operation may generate a unique packet indicating the end of the operation. The collective engine 304 sends the unique packet indicating the end of the operation to the collective engine 304 of the coprocessor 502 receiving the output array.

Tree 702 reflects an embodiment where eight input ports participate in the intersection operation, depicted as input ports 704a-704h, each of which may correspond to an input ports 302a-302c of FIG. 3. Therefore, tree 702 includes seven execution units 706a-706g. The output of an execution unit 706a-706g is fed to a flop 708a-708g, which allows the maximum value of a non-matching comparison to be reused in a next iteration, or a matching value to be passed on to another execution unit in the tree 702, until a final equivalent value output 710 is returned. The final equivalent value output 710 may be a value that is present in each of the input arrays.

In some embodiments, a data-flow approach is applied for processing an intersection operation. For example, when both inputs of a respective logic unit the receive valid data, a conditional comparison occurs. For example, when input ports 704a and 704b receive valid data (e.g., array elements), execution unit 706a may determine if the values match. If the values match, the value is forwarded through the network. If the values do not match, the maximum of the two values is determined and retained for the next iteration. This data-flow approach permeates through the tree 702 and the system 100. In some embodiments, the data-flow approach includes passing of “valid” bits with the elements of array data to indicate the elements include valid data. Furthermore, the data-flow approach includes inserting flops (e.g., flops 708a-708i) on the data paths. If input from one array arrives before input from another array, the comparison operation may wait for the input from the another array. This may cause backpressure through the input ports of the switch to the collective engine 304. The collective message queue 604 may store backpressured array elements to prevent blocking. Therefore, array input elements can arrive at any time and in any order and the final result will remain the same.

FIG. 7 further depicts a logical view of the datapath surrounding execution unit 706d in greater detail. Generally, the datapath for the execution unit 706d includes circuitry for performing the conditional “if-equal” comparisons for the intersection operation. As shown, execution unit 706d includes two logic units 718a-718b. Each logic unit 718a, 718b receives two elements of input, namely inputs 712a-712b and inputs 714a-714b, respectively. However, logical logic units 718a-718b are configured to reuse maximum values from a previous comparison computation that did not result in a match. For example, if input value input 712a is the maximum value selected from input 712a and 714a by execution unit 706d (where the values do not match), then input 714a may be reused in the next intersection “if-equal” computation iteration.

As shown, flop 708h and 708i flop the inputs preceding the “if-equal” computation performed by execution unit 706d. The result of the comparison operation performed by execution unit 706h determines if a matching value is to be passed to the next element in the tree 702, or in the case of non-equal input values, determining and holding the maximum value for the next comparison operation. If an input value is retained for the next comparison operation, the input into the execution stage for execution unit 706d is backpressured. In such an example, the collective message queue 604 of the slice 102a-102h providing the input array elements may hold one or more array elements to alleviate the backpressure.

As stated, as part of an intersection operation, an input array element may have no further elements to be processed. In such embodiments, the collective engine 304 may send an empty packet with an indication that the input array has been exhausted (e.g., by setting the array end bit depicted in Table II). When the collective engine 304 receives such an empty packet on an input port, the collective engine 304 only propagates valid input data values through the tree 702.

Furthermore, if the other input continues to receive actual array input values, the compare stage of the collective engine 304 may accept these values. However, the collective engine 304 does not perform any comparisons on these values. Instead, the collective engine 304 may pass these values on to allow the remaining input array packets to drain, which is required because the collective engine 304 of a coprocessor 502 will send all elements of its own input array regardless of the size of other input arrays.

For example, if input array A has no more elements for an intersection with input array B, the collective engine 304 propagates values from input B (and/or the empty packet) through the tree 702, thereby causing the remaining elements of the tree 702 to forego any processing (e.g., if-equal comparisons) of remaining input values from input array B. The empty array end packets may be propagated through the tree 702. Doing so causes the array end packets to be sent to the collective engine 304 of other switches 104a-104k (and/or the collective engine 304 of switches and/or coprocessors 502 in slices 102a-102h) involved in the intersection operation until collective engines 304 providing input arrays have issued array end packets that are received by the collective engine 304 receiving the final intersected output array. At this point, all execution units 706a-706h involved in the array intersection operation may reset their inputs and the in-network collective subsystem is ready for the next array intersection operation.

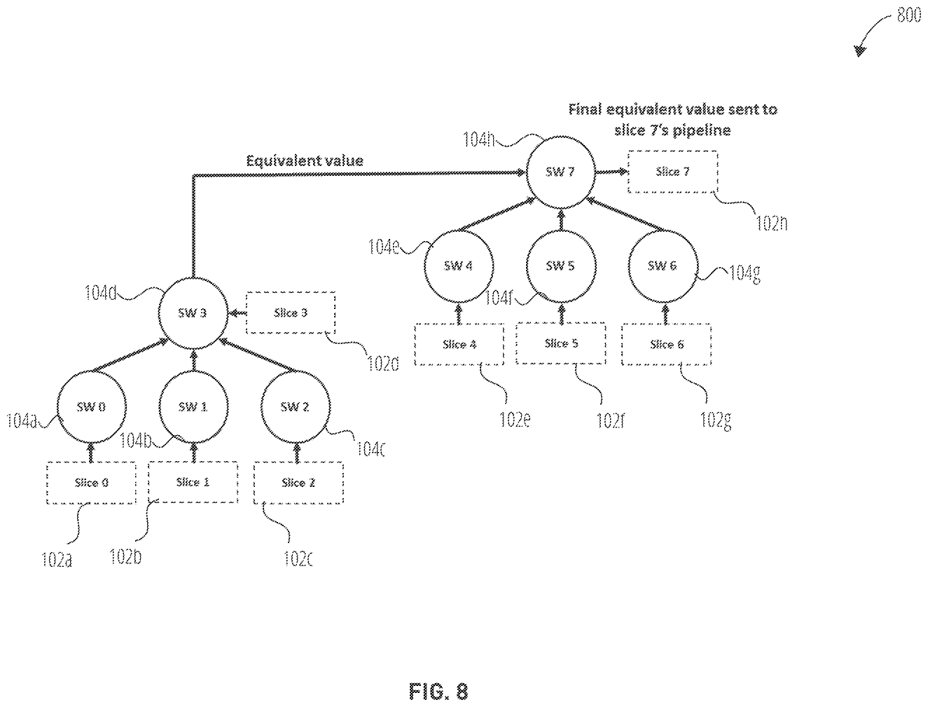

FIG. 8 illustrates an example topology 800 for an example sorted array intersection operation all pipelines 402a-402h in a single tile. In FIG. 8, seven of the slices (e.g., slices 102a-102g) contribute input arrays for the array intersection operation while one slice (e.g., slice 102h) receives the final intersected output array (which may include zero or more elements). In the example depicted in FIG. 8, each slice 102a-102h includes 8 pipelines, and a total of 64 pipeline 402a-402h are participating in the intersection operation for the tile. Generally, a value being outputted by each slice block is the intersected (e.g., common) value from the local pipeline 402a-402h of the slice.

For example, slices 102a-102g may contribute input array values, while slice 102h receives the final intersected output. In FIG. 8, the collective engines 304 of switch 104d of slice 102d and switch 104h of slice 102h execute the if-equal comparison operations. For example, the collective engine 304 of the switch 104d of slice 102d performs if-equal comparisons between values contributed by slices 102a-102d (e.g., if the comparison results in a match, forward the matching value; if the comparison does not result in a match, determine the maximum value and retain the maximum value for the next comparison). Similarly, the collective engine 304 of the switch 104h of slice 102h performs if-equal comparisons between values of inputs provided by slice 102d and slices 102e-102g. The final equivalent value outputted by the collective engine 304 of the switch of slice 102h is provided to the collective engine 304 of coprocessor 502 of slice 102h for writing to a memory address associated with the intersected output array. This process may repeat until all input array elements have been processed. Because the input and output array sizes are arbitrary, the configuration remains the same regardless of the size of the input and/or output arrays.

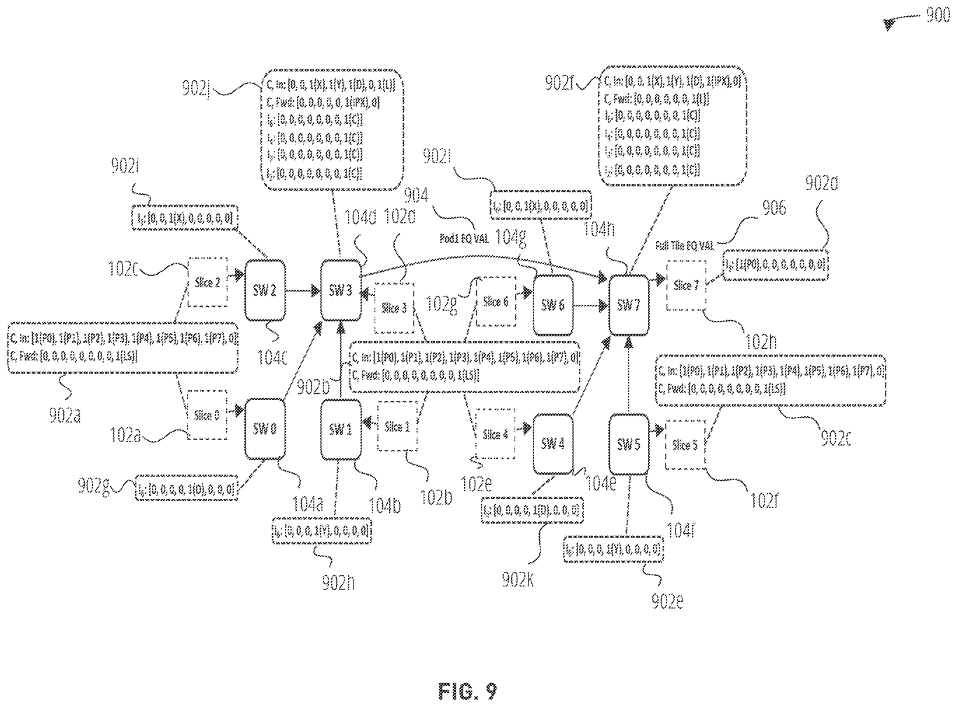

FIG. 9 is a schematic 900 illustrating example configuration values for each switch on a tile. Therefore, the configuration depicted in FIG. 9 may include configuration for one or more of switches 104a-104h, switches 104j-104k, and/or as switches within each slice 102a-102h (e.g., switch 104i and remaining switches not pictured in FIG. 1 for the sake of clarity).

The configuration for the switches depicted in FIG. 9 may be defined in Table IV below.

TABLE IV

| PORT | DESCRIPTION | NOTES |
|---|---|---|
| 0 | HSIO port 0 | Not used in example |
| 1 | HSIO port 1 | Not used in example |
| 2 | Intra-pod X-axis (for switch | Notated as X in FIG. 9 |
| | 104j or switch 104k) | |
| 3 | Intra-pod Y-axis (for switch | Notated as Y in FIG. 9 |
| | 104j or switch 104k) | |
| 4 | Intra-pod diagonal (for | Notated as D in FIG. 9 |
| | switch 104j or switch 104k) | |
| 5 | Inter-pod positive X-axis (for | Notated as IPX in FIG. |
| | switch 104j or switch 104k) | 9 |
| 6 | Local Slice | Notated as L in FIG. 9 |

As shown, Table IV includes port numbering to correspond to the ordering in the bit vectors for configuring a tree such as tree 702 or the topology 800. Table IV uses the term “pod” to refer to a localized group of four compute slices and localized switches. For example, a first pod may include slices 102a-102d and switches 104a-104d, while a second pod may include slices slice 102e-102h and switches 104e-104h.

As stated, each slice 102a-102h may coalesce the collective packets from its pipelines 402a-402h before sending the value to the intra-tile network. While the architectural organization of the collective engine 304 and crossbar of the slices 102a-102h is the same the collective engine 304 for a switch 104a-104k, the configuration register descriptions may vary slightly because the ports are the local pipelines (8 total) and the partner intra-tile switch (See Table IV for descriptions). In general, the pipeline's request paths are sent to the collective engine 304 of the slice 102a-102h or to the output port connecting to the local intra-tile switch. However, some embodiments allow for communication between pipelines 402a-402h.

Table V below illustrates switch port numbering used in the example of FIG. 9:

TABLE V

| PORT | DESCRIPTION | NOTES |
|---|---|---|
| 0 | Pipeline 0 (e.g., pipeline | Notated as P0 in FIG. 9 |
| | 402a) | |
| 1 | Pipeline 1 (e.g., pipeline | Notated as P1 in FIG. 9 |
| | 402b) | |
| 2 | Pipeline 2 (e.g., pipeline | Notated as P2 in FIG. 9 |
| | 402c) | |
| 3 | Pipeline 3 (e.g., pipeline | Notated as P3 in FIG. 9 |
| | 402d) | |
| 4 | Pipeline 4 (e.g., pipeline | Notated as P4 in FIG. 9 |
| | 402e) | |
| 5 | Pipeline 5 (e.g., pipeline | Notated as P5 in FIG. 9 |
| | 402f) | |
| 6 | Pipeline 6 (e.g., pipeline | Notated as P6 in FIG. 9 |
| | 402g) | |
| 7 | Pipeline 7 (e.g., pipeline | Notated as P7 in FIG. 9 |
| | 402h) | |
| 8 | Local Intra-Tile Switch (e.g., | Notated as LS in FIG. 9 |
| | switch 104a-104i, switch | |
| | 104j-104k, etc.) | |

As shown, FIG. 9 includes configuration 902a-9021, each of which may correspond to the data stored in configuration registers 310 and/or configuration registers 312 depicted in FIG. 3. For example, configuration 902a may include values for slice 102a and slice 102c, configuration 902b may include values for slices 102b, 102d, 102e, and 102g, configuration 902c may include values for slice 102f, and configuration 902d may include values for slice 102h. Furthermore, configurations 902e-9021 include configuration for switches 104a-104k.

Generally, within each slice 102a-102h, the values from all pipelines 402a-402h are intersected first. Only values that are equivalent from all pipelines 402a-402h are sent into the intra-tile network. The configuration for each slice 102a-102h may result in each pipeline 402a-402h is input to the collective engine 304 of the coprocessor 502 of the respective slice, and the result is forwarded to the output port connecting to the output tile switch 104a-104k. For example, slice 102a may send a message including a result of the if-equal comparisons for each input array to the switch 104a (e.g., an equivalent value output 710).

When the collective engine 304 of switch 104a-104k of a local slice 102a-102h sends a message with a value to contribute to the intersection, the 16 configuration register for the switch 104a-104k indicates that the switch 104a-104k will send the message. In some embodiments, the message may be sent to one of switch 104d (e.g., for switches 104a-104c) or switch 104h (for switches 104d-104g).

Switch 104d and switch 104h are configured to receive inputs from the three neighbor switches in their pods (e.g., switches 104a-104c and switches 104d-104g, respectively). The I₂, I₃, and I₄ configuration registers specify that these inputs should go to the collective engine 304 of switch 104d or switch 104h. For example, the 12, 13, and 14 registers in configuration 902j for switch 104d specify that the inputs go to the collective engine 304 of switch 104d, while the registers I₂, I₃, and I₄ in configuration 902f for switch 104h specify that the inputs go to the collective engine 304 of switch 104h.

The C,in configuration register in configuration 902j for switch 104d specifies that the inputs from the neighbor switches in pod 1 (e.g., switches 104a-104c), as well as the value from local slice 102d, will be input into collective engine 304 of switch 104d. The C,fwd register in configuration 902j for switch 104d specifies that the output of the intersection will be sent to switch 104h.

The C,in configuration register in configuration 902f for switch 104h specifies that the inputs from the neighbor switches in pod 2 (e.g., switches 104e-104g) and the value received from switch 104d will be input into the collective engine 304 of switch 104h. The C,fwd register in configuration 902f for switch 104h specifies that the output of the intersection locally will be sent to local slice 102h.

Once the final intersected value is received by slice 102h, the configuration register Is configuration 902c specifies that the intersected value is forwarded to the collective engine 304 of coprocessor 502 of pipeline 402a, where the intersected value is stored to memory. The slice 102h may then wait to receive the next output element or an ‘end of array’ indication.

In addition to the configuration register values, FIG. 9 reflects the propagation of a single message through the network for an intersection operation. The larger array intersection operation sees each input (e.g., all pipelines 402a-402h in all slices 102a-102g) sending multiple values into the collective subsystem. However, only values that are equivalent among all participants (or ‘end of array’ indications) will propagate through the network collective subsystem. For example, a message 904 reflects that an equivalent value (e.g., “222”) was present in each array processed by slices 102a-102d. Messages sent by slices 102a-102c indicating the equivalent value is present in each array being processed therein are not depicted for the sake of clarity. Similarly, a message 906 may indicate, to slice 102h, that the equivalent value (e.g., “222” of the previous example) is present in each array being processed by slices 102a-102g. More generally, a given propagation will take the path shown in FIG. 9, with each propagation ending at the collective engine 304 of coprocessor 502 of pipeline 402a of switch 104h.

In this example, full propagation of a message originating from any pipeline on the tile to the final target slice/pipeline takes no more than four steps (and three switch hops). In some embodiments, these configurations can be reduced to include only a subset of slices/pipelines on the tile or expanded to other tiles/sockets in the system via the HSIO ports 106a-106b connected to the switches.

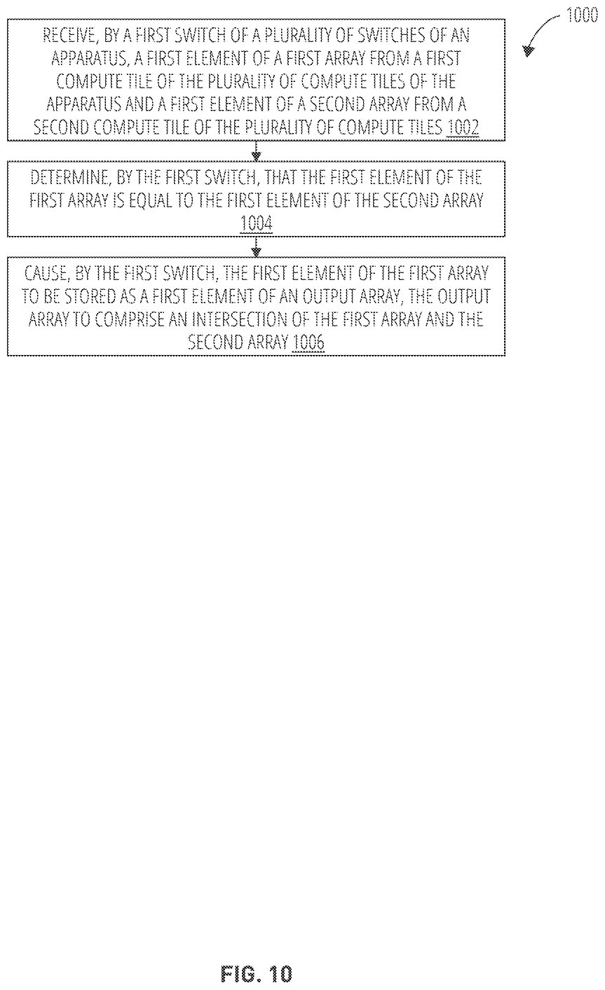

FIG. 10 depicts a logic flow 1000. Logic flow 1000 may be representative of some or all of the operations for multi-dimensional network sorted array intersection. Embodiments are not limited in this context.

In block 1002, logic flow 1000 receives, by a first switch (e.g., switch 104a) of a plurality of switches (e.g., switches 104a-104k) of an apparatus (e.g., system 100), a first element of a first array from a first compute tile of the plurality of compute tiles and a first element of a second array from a second compute tile of the plurality of compute tiles. In block 1004, logic flow 1000 determines, by the first switch, that the first element of the first array is equal to the first element of the second array. In block 1006, logic flow 1000 causes, by the first switch, the first element of the first array to be stored as a first element of an output array, the output array to comprise an intersection of the first array and the second array.

The logic flow 1000 may continue for any number of iterations, e.g., by receiving more elements of the first and second arrays based on the first element of the first array matching the first element of the second array. If compared elements do not match, the maximum value among the compared elements is determined and retained for a subsequent iteration. For example, if a second element of the first array is greater than a second element of the second array, the second element of the first array is retained to be compared by against a third element of the second array. These iterations may continue until at least one of the arrays has no remaining elements for the intersection operation. Doing so may cause the switch to forward an end of array message throughout the network. Embodiments are not limited in these contexts.

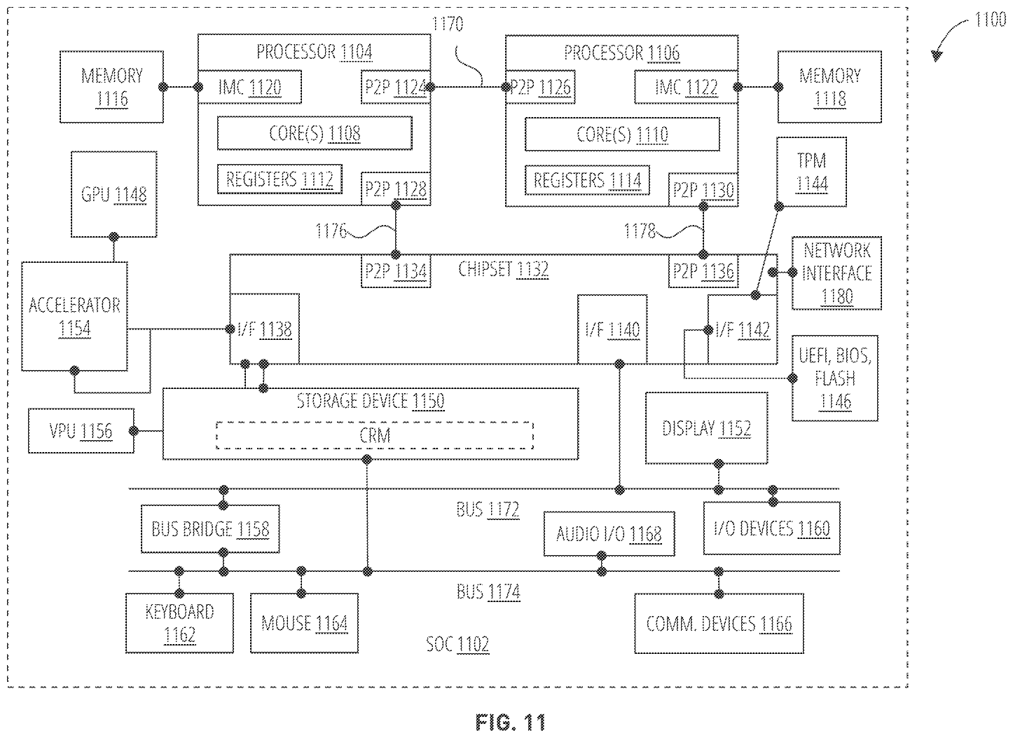

FIG. 11 illustrates an embodiment of a system 1100. System 1100 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the system 1100 may have a single processor with one core or more than one processor. Note that the term “processor” refers to a processor with a single core or a processor package with multiple processor cores. In at least one embodiment, the computing system 1100 is representative of the components of the system 100. More generally, the computing system 1100 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary system 1100. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in FIG. 11, system 1100 comprises a system-on-chip (SoC) 1102 for mounting platform components. System-on-chip (SoC) 1102 is a point-to-point (P2P) interconnect platform that includes a first processor 1104 and a second processor 1106 coupled via a point-to-point interconnect 1170 such as an Ultra Path Interconnect (UPI). In other embodiments, the system 1100 may be of another bus architecture, such as a multi-drop bus. Furthermore, each of processor 1104 and processor 1106 may be processor packages with multiple processor cores including core(s) 1108 and core(s) 1110, respectively. While the system 1100 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to a motherboard with certain components mounted such as the processor 1104 and chipset 1132. Some platforms may include additional components and some platforms may only include sockets to mount the processors and/or the chipset. Furthermore, some platforms may not have sockets (e.g. SoC, or the like). Although depicted as a SoC 1102, one or more of the components of the SoC 1102 may also be included in a single die package, a multi-chip module (MCM), a multi-die package, a chiplet, a bridge, and/or an interposer. Therefore, embodiments are not limited to a SoC.

The processor 1104 and processor 1106 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processor 1104 and/or processor 1106. Additionally, the processor 1104 need not be identical to processor 1106.

Processor 1104 includes an integrated memory controller (IMC) 1120 and point-to-point (P2P) interface 1124 and P2P interface 1128. Similarly, the processor 1106 includes an IMC 1122 as well as P2P interface 1126 and P2P interface 1130. IMC 1120 and IMC 1122 couple the processor 1104 and processor 1106, respectively, to respective memories (e.g., memory 1116 and memory 1118). Memory 1116 and memory 1118 may be portions of the main memory (e.g., a dynamic random-access memory (DRAM)) for the platform such as double data rate type 4 (DDR4) or type 5 (DDR5) synchronous DRAM (SDRAM). In the present embodiment, the memory 1116 and the memory 1118 locally attach to the respective processors (e.g., processor 1104 and processor 1106). In other embodiments, the main memory may couple with the processors via a bus and shared memory hub. Processor 1104 includes registers 1112 and processor 1106 includes registers 1114.

System 1100 includes chipset 1132 coupled to processor 1104 and processor 1106. Furthermore, chipset 1132 can be coupled to storage device 1150, for example, via an interface (I/F) 1138. The I/F 1138 may be, for example, a Peripheral Component Interconnect-enhanced (PCIe) interface, a Compute Express Link® (CXL) interface, or a Universal Chiplet Interconnect Express (UCIe) interface. Storage device 1150 can store instructions executable by circuitry of system 1100 (e.g., processor 1104, processor 1106, GPU 1148, accelerator 1154, vision processing unit 1156, or the like). For example, storage device 1150 can store instructions for a sorted array intersection operation, or the like.

Processor 1104 couples to the chipset 1132 via P2P interface 1128 and P2P 1134 while processor 1106 couples to the chipset 1132 via P2P interface 1130 and P2P 1136. Direct media interface (DMI) 1176 and DMI 1178 may couple the P2P interface 1128 and the P2P 1134 and the P2P interface 1130 and P2P 1136, respectively. DMI 1176 and DMI 1178 may be a high-speed interconnect that facilitates, e.g., eight Giga Transfers per second (GT/s) such as DMI 3.0. In other embodiments, the processor 1104 and processor 1106 may interconnect via a bus.

The chipset 1132 may comprise a controller hub such as a platform controller hub (PCH). The chipset 1132 may include a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1132 may comprise more than one controller hub such as a chipset with a memory controller hub, a graphics controller hub, and an input/output (I/O) controller hub.

In the depicted example, chipset 1132 couples with a trusted platform module (TPM) 1144 and UEFI, BIOS, FLASH circuitry 1146 via I/F 1142. The TPM 1144 is a dedicated microcontroller designed to secure hardware by integrating cryptographic keys into devices. The UEFI, BIOS, FLASH circuitry 1146 may provide pre-boot code.

Furthermore, chipset 1132 includes the I/F 1138 to couple chipset 1132 with a high-performance graphics engine, such as, graphics processing circuitry or a graphics processing unit (GPU) 1148. In other embodiments, the system 1100 may include a flexible display interface (FDI) (not shown) between the processor 1104 and/or the processor 1106 and the chipset 1132. The FDI interconnects a graphics processor core in one or more of processor 1104 and/or processor 1106 with the chipset 1132.

Additionally, accelerator 1154 and/or vision processing unit 1156 can be coupled to chipset 1132 via I/F 1138. The accelerator 1154 is representative of any type of accelerator device (e.g., a data streaming accelerator, cryptographic accelerator, cryptographic coprocessor, an offload engine, etc.). The accelerator 1154 may be a device including circuitry to accelerate copy operations, data encryption, hash value computation, data comparison operations (including comparison of data in memory 1116 and/or memory 1118), and/or data compression. For example, the accelerator 1154 may be a USB device, PCI device, PCIe device, CXL device, UCIe device, and/or an SPI device. The accelerator 1154 can also include circuitry arranged to execute machine learning (ML) related operations (e.g., training, inference, etc.) for ML models. Generally, the accelerator 1154 may be specially designed to perform computationally intensive operations, such as hash value computations, comparison operations, cryptographic operations, and/or compression operations, in a manner that is more efficient than when performed by the processor 1104 or processor 1106. Because the load of the system 1100 may include hash value computations, comparison operations, cryptographic operations, and/or compression operations, the accelerator 1154 can greatly increase performance of the system 1100 for these operations.

The accelerator 1154 may include one or more dedicated work queues and one or more shared work queues (each not pictured). Generally, a shared work queue is configured to store descriptors submitted by multiple software entities. The software may be any type of executable code, such as a process, a thread, an application, a virtual machine, a container, a microservice, etc., that share the accelerator 1154. For example, the accelerator 1154 may be shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1154 via a non-posted write (e.g., a deferred memory write (DMWr)). One example of an instruction that atomically submits a work descriptor to the shared work queue of the accelerator 1154 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1154. The dedicated work queue may accept job submissions via commands such as the movdir64b instruction.

Various I/O devices 1160 and display 1152 couple to the bus 1172, along with a bus bridge 1158 which couples the bus 1172 to a second bus 1174 and an I/F 1140 that connects the bus 1172 with the chipset 1132. In one embodiment, the second bus 1174 may be a low pin count (LPC) bus. Various devices may couple to the second bus 1174 including, for example, a keyboard 1162, a mouse 1164 and communication devices 1166.

The system 1100 is operable to communicate with wired and wireless devices or entities via the network interface 1180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE, 5G, 6G wireless technologies, among others. Thus, the communication can be a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network can be used to connect computers to each other, to the Internet, and to wired networks (which use IEEE 802.3-related media and functions).

Furthermore, an audio I/O 1168 may couple to second bus 1174. Many of the I/O devices 1160 and communication devices 1166 may reside on the system-on-chip (SoC) 1102 while the keyboard 1162 and the mouse 1164 may be add-on peripherals. In other embodiments, some or all the I/O devices 1160 and communication devices 1166 are add-on peripherals and do not reside on the system-on-chip (SoC) 1102.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The various elements of the devices as previously described with reference to FIGS. 1-6 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

The following examples pertain to further embodiments, from which numerous permutations and configurations will be apparent.

Examples will be added when claims are finalized

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. An apparatus, comprising:
a network comprising a plurality of switches; and
a plurality of compute tiles coupled to the network,
wherein a first switch of the plurality of switches is to comprise circuitry to:
receive a first element of a first array from a first compute tile of the plurality of compute tiles and a first element of a second array from a second compute tile of the plurality of compute tiles;
determine that the first element of the first array is equal to the first element of the second array; and
cause the first element of the first array to be stored as a first element of an output array, the output array to comprise an intersection of the first array and the second array.

2. The apparatus of claim 1, wherein the first compute tile is to comprise circuitry to:
determine the first element of the first array is present in respective arrays of a plurality of arrays, respective arrays of the plurality of arrays to be processed by respective ones of a plurality of compute slices of the first compute tile.

3. The apparatus of claim 1, wherein the first switch of the plurality of switches is to comprise circuitry to:
receive a second element of the first array and a second element of the second array;
determine the second element of the first array is not equal to the second element of the second array; and
determine the second element of the first array is greater than the second element of the second array.

4. The apparatus of claim 3, wherein the first switch of the plurality of switches is to comprise circuitry to:
retain the second element of the first array based on the second element of the first array being greater than the second element of the second array;
receive a third element of the second array; and
compare the second element of the first array to the third element of the second array.

5. The apparatus of claim 1, wherein the first switch of the plurality of switches is to comprise circuitry to:
receive, from a second switch of the plurality of switches, an indication that no additional elements of the output array are to be received from the second switch; and
refrain, based on the received indication, from initiating a comparison based on a second element of the first array.

6. The apparatus of claim 5, wherein the first switch of the plurality of switches is to comprise circuitry to:
forward the indication to a coprocessor of a first compute tile of the plurality of compute tiles, the coprocessor associated with a processor pipeline to execute a thread to receive the output array.

7. The apparatus of claim 1, wherein the first switch determines to perform a comparison between the first element of the first array and the first element of the second array based on a configuration of the first switch.

8. The apparatus of claim 1, wherein the first switch causes the first element of the first array to be stored as the first element of the output array via a first output port of a plurality of output ports of the first switch, wherein the first output port is based on a configuration of the first switch.

9. The apparatus of claim 1, wherein the first element of the first array is received based on an instruction defined by an Instruction Set Architecture (ISA), wherein the ISA is supported by a respective coprocessor of the plurality of compute tiles.

10. The apparatus of claim 1, wherein a configuration of the first switch defines at least a portion of a tree to generate the output array.

11. A method, comprising:
receiving, by a first switch of a plurality of switches of an apparatus, a first element of a first array from a first compute tile of the plurality of compute tiles of the apparatus and a first element of a second array from a second compute tile of the plurality of compute tiles;
determining, by the first switch, that the first element of the first array is equal to the first element of the second array; and
causing, by the first switch, the first element of the first array to be stored as a first element of an output array, the output array to comprise an intersection of the first array and the second array.

12. The method of claim 11, further comprising:
determining, by the first compute tile, the first element of the first array is present in respective arrays of a plurality of arrays, respective arrays of the plurality of arrays to be processed by respective ones of a plurality of compute slices of the first compute tile.

13. The method of claim 11, further comprising:
receiving, by the first switch, a second element of the first array and a second element of the second array;
determining, by the first switch, the second element of the first array is not equal to the second element of the second array; and
determining, by the first switch, the second element of the first array is greater than the second element of the second array.

14. The method of claim 13, further comprising:
retaining, by the first switch, the second element of the first array based on the second element of the first array being greater than the second element of the second array;
receiving, by the first switch, a third element of the second array; and
comparing, by the first switch, the second element of the first array to the third element of the second array.

15. The method of claim 11, further comprising:
receiving, by the first switch from a second switch of the plurality of switches, an indication that no additional elements of the output array are to be received from the second switch; and
refrain, by the first switch based on the received indication, from initiating a comparison based on a second element of the first array.

16. The method of claim 15, further comprising:
forwarding, by the first switch, the indication to a coprocessor of a first compute tile of the plurality of compute tiles, the coprocessor associated with a processor pipeline to execute a thread to receive the output array.

17. The method of claim 11, wherein a network of the apparatus includes the plurality of switches.

18. A non-transitory computer-readable storage medium, the computer-readable storage medium including instructions that when executed by a processor, cause the processor to:
receive, by a first switch of a plurality of switches, a first element of a first array from a first compute tile of a plurality of compute tiles and a first element of a second array from a second compute tile of the plurality of compute tiles;
determine, by the first switch, that the first element of the first array is equal to the first element of the second array; and
cause, by the first switch, the first element of the first array to be stored as a first element of an output array, the output array to comprise an intersection of the first array and the second array.

19. The computer-readable storage medium of claim 18, wherein the instructions further cause the processor to:
receive, by the first switch, a second element of the first array and a second element of the second array;
determine, by the first switch, the second element of the first array is not equal to the second element of the second array; and
determine, by the first switch, the second element of the first array is greater than the second element of the second array.

20. The computer-readable storage medium of claim 19, wherein the instructions further cause the processor to:
retain, by the first switch, the second element of the first array based on the second element of the first array being greater than the second element of the second array;
receive, by the first switch, a third element of the second array; and
compare, by the first switch, the second element of the first array to the third element of the second array.
